(19) United States
(12) Patent Application Publication
(10) Pub. No.: US 2026/0347181 A1
(43) Pub. Date: Nov. 5, 2026

(54) IODINE RECOVERY METHOD AND APPARATUS

(71) Applicants: SK INNOVATION CO., LTD., Seoul (KR); SK ON CO., LTD., Seoul (KR)

(72) Inventors: Jae Hun JEONG, Daejeon (KR); Soo Kil KANG, Daejeon (KR); Hee Du LEE, Daejeon (KR)

(21) Appl. No.: 19/641,536

(22) Filed: Apr. 8, 2026

(30) Foreign Application Priority Data
Apr. 30, 2025 (KR) 10-2025-0057727
Aug. 29, 2025 (KR) 10-2025-0122234

(51) Int. Cl. C01B 7/14; B01D 7/02

(52) U.S. Cl. CPC C01B 7/14; B01D 7/02

(57) ABSTRACT

The present disclosure relates to an iodine recovery apparatus, including a main chamber; at least one first inlet connected to the main chamber, the first inlet being configured to introduce a cooling gas into the main chamber; a second inlet connected to the main chamber and spaced apart from the at least one first inlet, the second inlet being configured to introduce iodine in a gaseous state into the main chamber; and a first outlet connected to the main chamber and configured to discharge, from the main chamber, iodine that has been precipitated in the main chamber. The main chamber is configured so that the iodine in a gaseous state is cooled by being brought into contact with the cooling gas , thereby causing the iodine in a gaseous state to be precipitated as precipitated iodine. A related method for recovering iodine is also disclosed.

### CROSS-REFERENCE TO RELATED APPLICATION

This patent application claims the priority and benefits of Korean patent application No. 10-2025-0057727, filed on Apr. 30, 2025 and Korean patent application No. 10-2025-0122234, filed on Aug. 29, 2025, the disclosure of which is incorporated herein by reference in its entirety.

### BACKGROUND OF THE INVENTION

### 1. Field of the Invention

The present disclosure relates to an iodine recovery method and an iodine recovery apparatus.

### 2. Description of the Related Art

Iodine is a high-value substance used in various chemical processes. Research is being conducted on techniques for recovering iodine from a mixed gas generated after a reaction.

Typically, to recover iodine from a mixed gas, a method of precipitating (desublimating) iodine into a solid state through cooling is used.

In such a method, precipitated iodine may adhere to inner walls of an apparatus, which may result in pipe clogging, reduced heat transfer, and process interruptions. In particular, if solid iodine accumulates beyond a certain thickness, the above-described problems may be exacerbated, thereby making continuous process operation difficult.

### SUMMARY OF THE INVENTION

An object of the present disclosure is to provide an apparatus and a method for separating and recovering iodine from a gas mixture.

An iodine recovery apparatus according to embodiments of the present disclosure may include: a main chamber; at least one first inlet connected to the main chamber, the at least one first inlet being configured to introduce a cooling gas into the main chamber; a second inlet connected to the main chamber and spaced apart from the at least one first inlet, the second inlet being configured to introduce iodine in a gaseous state into the main chamber; and a first outlet connected to the main chamber, the first outlet being configured to discharge, from the main chamber, iodine that has been precipitated in the main chamber. The main chamber is configured so that the iodine in a gaseous state is cooled by being brought into contact with the cooling gas in the main chamber, thereby causing the iodine in a gaseous state to be precipitated as precipitated iodine.

In embodiments, a dispersion plate may be disposed within the main chamber, wherein the dispersion plate may include a plurality of dispersion holes extending therethrough, wherein the dispersion plate is disposed between the at least one first inlet and the second inlet, and wherein the second inlet and the dispersion plate are configured so that the iodine in a gaseous state can pass through the dispersion holes and may be dispersed within the main chamber.

In embodiments, an upper surface of the dispersion plate may have an upwardly convex shape.

In embodiments, spacings between at least some of the plurality of dispersion holes extending through the dispersion plate may be different from each other.

In embodiments, the spacing between the plurality of dispersion holes may decrease toward a central portion of the dispersion plate.

In embodiments, the dispersion plate may be disposed at a height at which the first outlet is in communication with the main chamber.

In embodiments, the iodine recovery apparatus may further include a rotary vane unit disposed above the dispersion plate, wherein the rotary vane unit is configured to rotate, thereby moving the precipitated iodine toward an edge portion of the dispersion plate.

In embodiments, the at least one first inlet may be connected to the main chamber so as to be inclined downward toward the main chamber.

In embodiments, the at least one first inlet may comprise a plurality of first inlets, and at least one of the plurality of first inlets may be configured to introduce a dispersion gas into the main chamber.

In embodiments, the iodine recovery apparatus may further include a discharge member disposed in the first outlet and configured to discharge the precipitated iodine from the main chamber.

In embodiments, the discharge member may include at least one of an auger and a screw.

In embodiments, the iodine recovery apparatus may further include a second outlet opening into the main chamber, the second outlet may be configured to allow at least one of the cooling gas, the iodine in a gaseous state, and the precipitated iodine in an upper portion of the main chamber to be discharged from the main chamber.

In embodiments, the iodine recovery apparatus may further include a cyclone separator connected to the second outlet and configured to recover the precipitated iodine discharged through the second outlet.

An iodine recovery method according to embodiments of the present disclosure may include: introducing a cooling gas into a main chamber through a first inlet; introducing iodine in a gaseous state into the main chamber through a second inlet spaced apart from the first inlet; cooling the iodine in a gaseous state by contacting the iodine in gaseous state with the cooling gas to precipitate the iodine; and discharging the precipitated iodine from the main chamber.

In embodiments, the introducing iodine in a gaseous state into the main chamber may further comprise dispersing, the iodine and introducing the iodine into the main chamber through a dispersion plate disposed within the main chamber.

In embodiments, an upper surface of the dispersion plate may be convexly formed upward.

In embodiments, the dispersion plate may have a plurality of dispersion holes extending therethrough, and spacings between at least some of the plurality of dispersion holes may be different from each other.

In embodiments, the spacing between the plurality of dispersion holes may decrease toward a central portion of the dispersion plate.

In embodiments, the first inlet may be connected to the main chamber so as to be inclined downward toward the main chamber.

In embodiments, the main chamber may further include a rotary vane unit disposed above the dispersion plate, the rotary vane unit is configured to rotate, thereby moving the precipitated iodine toward an edge portion of the dispersion plate.

According to an embodiment of the present disclosure, a low-temperature gas may be sprayed into a gas mixture such that gaseous iodine included in the gas mixture is cooled and precipitated as solid iodine. Accordingly, the amount of iodine discharged without being recovered may be reduced, thereby increasing the iodine recovery rate.

In addition, according to an embodiment of the present disclosure, the gas mixture may be cooled such that the gaseous iodine included in the gas mixture may be desublimated and precipitated as fine solid particles. Accordingly, the solid iodine may be discharged in a fine particle form without growing into large crystalline aggregates, thereby preventing clogging of an outlet and enabling continuous process operation.

Furthermore, according to an embodiment of the present disclosure, gaseous iodine may be cooled and precipitated upon contact with a gaseous cooling gas, and thus may be precipitated without being dissolved in a cooling medium. Therefore, the iodine recovery rate may be improved as compared with a method in which iodine is precipitated from a solution.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a conceptual diagram of an iodine recovery apparatus according to an embodiment of the present disclosure;

FIG. 2 is a plan view of a dispersion plate shown in FIG. 1.

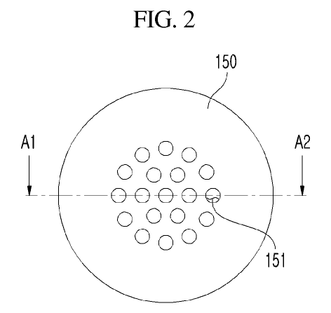

FIG. 3 is a cross-sectional view taken along line A1-A2 of FIG. 2;

FIG. 4 is a block diagram illustrating connection relationships between some components constituting the iodine recovery apparatus according to an embodiment of the present disclosure;

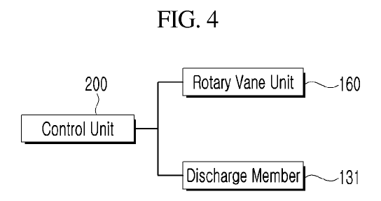

FIG. 5 is a flowchart illustrating an operating sequence of each component of the iodine recovery apparatus according to an embodiment of the present disclosure; and

FIG. 6 is a flowchart illustrating an iodine recovery method according to an embodiment of the present disclosure.

### DETAILED DESCRIPTION OF THE INVENTION

The embodiments of the present disclosure are provided to more fully describe the present disclosure to those skilled in the art to which the present invention pertains. The following embodiments may be modified in various forms, and the scope of the present disclosure is not limited to these embodiments.

Hereinafter, some embodiments of the present disclosure will be described through exemplary drawings for the convenience of description. When assigning reference numerals to components of the respective drawings, it should be noted that the same components will be denoted by the same reference numerals, even if they appear in different drawings.

The terms or words used in this specification and the claims should not be construed as being limited to their conventional or lexical meanings, and instead, in accordance with the principle that an inventor may define the concepts of terms or words in the most appropriate manner to describe the invention, they should be interpreted based on the meanings and concepts that meet the technical spirit of the present disclosure.

The terms used herein are provided to describe specific embodiments and are not intended to limit the present disclosure. As used herein, the singular form may include the plural form unless the context clearly dictates otherwise.

In addition, when used to describe and define the present disclosure, terms, such as “comprise,” “include,” “have,” and the like, should be interpreted in a non-exclusive manner. Unless explicitly stated otherwise, these terms should be construed to imply that the presence of the corresponding component, and not to exclude but rather include other components.

In addition, in describing components of the embodiment of the present disclosure, the terms, such as first, second, A, B, (a), (b), and the like, may be used. These terms are used to distinguish the component from other components and do not impose any limitations on their nature, sequence or order, etc.

It will be understood that when a component is described as being “connected” or “coupled” (or the like) to another component, the component may be directly connected or coupled to the other component, but it may be “connected” or “coupled” to the other component with another component possibly interposed.

Space-related terms, such as “beneath,” “below,” “lower,” “above,” “upper,” and the like, may be used to aid in the understanding of the relationship between an element or feature and another illustrated in the drawings. These space-related terms are provided to aid in the understanding of the present disclosure in various processing or usage states and are not intended to impose any limitations on the present disclosure. For example, if an element or feature in the drawing is turned upside down, the element or feature described as “beneath” or “below” becomes “above” or “upper.” Accordingly, the term “beneath” is a relative concept that may encompass “upper” as well as “below” depending on orientation.

The embodiments described in this specification and the configurations illustrated in the drawings merely represent the most preferred embodiments of the present disclosure but do not encompass all aspects of the technical spirit of the present disclosure. Thus, it should be understood that various modifications and equivalents may be implemented at the time of filing the present application. In addition, the publicly known functions and configurations that are deemed unnecessary for clarifying the essence of the present invention will not be described.

Hereinafter, an iodine recovery apparatus according to an embodiment of the present disclosure will be described in detail with reference to the accompanying drawings.

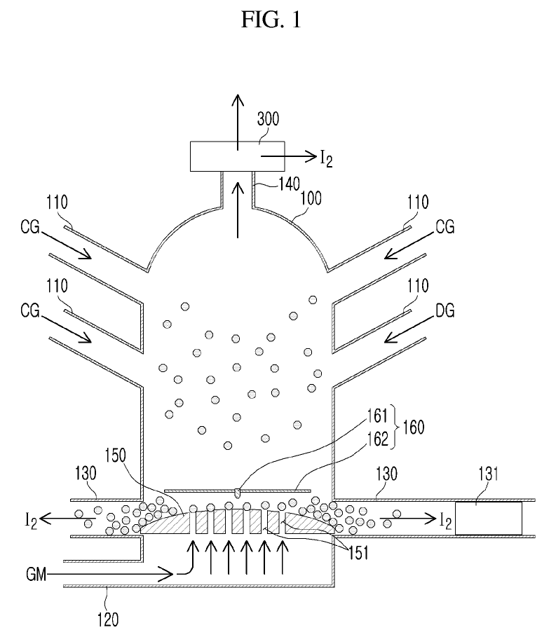

Referring to FIGS. 1 - 4, the iodine recovery apparatus according to an embodiment of the present disclosure may include a main chamber 100.

The main chamber may include a first inlet 110, a second inlet 120, a first outlet 130, and a second outlet 140.

The first inlet 110 may be connected to the main chamber 100. For example, the first inlet 110 may be connected to an upper portion of the main chamber 100. A cooling gas CG may be introduced into the main chamber 100 through the first inlet 110.

The cooling gas may be a gas or a mixture of gases having low reactivity with iodine. For example, the cooling gas may be dried air or nitrogen.

The cooling gas may have a temperature of 50° C or lower. The cooling gas may be cooled and introduced into the main chamber 100 through the first inlet 110. Alternatively, the first inlet 110 may be cooled to reduce the temperature of the cooling gas flowing through the first inlet 110.

The cooling gas may contact gaseous iodine within the main chamber 100 to reduce the temperature of the iodine. For example, the cooling gas may contact iodine at a relatively high-temperature state and exchange heat with the iodine.

For example, the first inlet 110 may be connected so as to be inclined downward toward the main chamber 100. In this case, the cooling gas may be more easily introduced into the main chamber 100. In addition, as the cooling gas flows into the main chamber 100, the cooling gas may contact iodine and move the precipitated iodine toward an edge portion of a dispersion plate 150.

A plurality of first inlets 110 may be provided. The plurality of first inlets 110 may be connected to the main chamber 100 along a circumferential direction of the main chamber 100. For example, the plurality of first inlets 110 may be disposed to face each other. Alternatively, the plurality of first inlets 110 may be spaced apart at approximately 90° intervals.

The plurality of first inlets 110 may be connected to the main chamber 100 along a vertical direction of the main chamber 100.

The height or spacing at which the plurality of first inlets 110 are disposed may be varied as needed.

A dispersion gas DG may be introduced into the main chamber 100 through at least one of the plurality of first inlets 110. The dispersion gas may be a gas or a mixture of gases having low reactivity with iodine.

The dispersion gas may be introduced into the main chamber 100 through the first inlet 110 to move the precipitated iodine. For example, the dispersion gas may be sprayed at high pressure. The dispersion gas may be introduced into the main chamber 100 through the downwardly inclined first inlet 110. The dispersion gas may flow into the main chamber 100 and, due to the pressure, may move the precipitated iodine to the edge portion of the dispersion plate 150.

The second inlet 120 may be connected to the main chamber 100 to be spaced apart from the first inlet 110. For example, the second inlet 120 may be connected to a lower portion of the main chamber 100. For example, the first inlet 110 and the second inlet 120 may be disposed parallel to each other in a horizontal direction. For example, the first inlet 110 may be connected to one side of the main chamber 100, and the second inlet 120 may be connected to the other side of the main chamber 100.

Gaseous iodine may be introduced into the main chamber 100 through the second inlet 120. The gaseous iodine may be introduced into the main chamber 100 through the second inlet 120, or otherwise, a gas mixture GM including gaseous iodine may be introduced into the main chamber 100 through the second inlet 120.

The gas mixture may flow through the second inlet 120 and be introduced into the main chamber 100.

For example, the gas mixture may be a reactor effluent.

For example, the gas mixture may include gaseous iodine and a non-condensable gas.

For example, the non-condensable gas may include halogenated hydrocarbons. The non-condensable gas, excluding iodine vapor, may have a boiling point of 50° C or lower.

For example, if the boiling point of the non-condensable gas is 50° C or higher, the non-condensable gas may be dissolved in a low-temperature solvent or act as an impurity, thereby reducing the iodine recovery rate. For example, when the non-condensable gas is liquefied or deposited as a solid, it may be difficult to separate the non-condensable gas from the solid iodine to be recovered.

For example, if the boiling point of the non-condensable gas is 50° C or lower, iodine may be selectively recovered from the substances contained in the gas mixture, thereby improving the purity of iodine.

The temperature of the gas mixture introduced into the main chamber 100 through the second inlet 120 may be 150° C to 250° C.

The gas mixture may be heated before being introduced into the second inlet 120. Alternatively, the second inlet 120 may be heated to increase the temperature of the gas mixture.

For example, the pressure within the main chamber 100 may be in a range of 1 atm to 3 atm. In this case, when the temperature of the gas mixture is 150° C to 250° C, the iodine included in the gas mixture introduced into the main chamber 100 may be present in a gaseous state.

Hereinafter, a gas mixture including gaseous iodine will be described as being introduced into the main chamber 100. However, it will be understood that as an alternative only gaseous iodine, rather than a gas mixture, may be introduced.

The gas mixture may be introduced into the main chamber 100 through the second inlet 120. The gas mixture may contact the cooling gas that is introduced into the main chamber 100 through the first inlet 110.

For example, the cooling gas may have a temperature of 50° C or lower.

The hot gas mixture may come into contact with a cooling gas having a temperature of 50 °C or lower. The gas mixture and the cooling gas in contact with each other may exchange heat. The gaseous iodine included in the gas mixture may be cooled by the cooling gas. The gaseous iodine may be converted into solid iodine. At least a portion of the gaseous iodine may be precipitated as solid iodine.

The dispersion plate 150 may be disposed between the second inlet 120 and the first inlet 110. The dispersion plate 150 may be disposed within the main chamber 100.

A plurality of dispersion holes 151 may be formed through the thickness of the dispersion plate 150. At least some of the plurality of dispersion holes 151 may have spacings different from each other.

The dispersion holes 151 may be disposed in portions other than an edge portion of the dispersion plate 150. When the dispersion holes 151 are disposed at the edge portion of the dispersion plate 150, the gas mixture may be dispersed toward a wall surface of the main chamber 100 through the dispersion holes 151 formed at the edge portion of the dispersion plate 150. In this case, the gas mixture may contact the cooling gas on the wall surface of the main chamber 100. The gaseous iodine included in the gas mixture may be cooled upon contact with the cooling gas on the wall surface of the main chamber 100. At least some of the gaseous iodine may form and grow crystals on the wall surface of the main chamber 100 rather than being deposited as solid iodine. Therefore, an internal volume of the main chamber 100 may decrease. Alternatively, the iodine grown into crystals may be fixed to the wall surface of the main chamber 100 and may be difficult to discharge through the first outlet 130.

The plurality of dispersion holes 151 may be arranged in a regular pattern. For example, the spacing between the dispersion holes 151 may regularly decrease from the edge portion toward a center of the dispersion plate 150.

The plurality of dispersion holes 151 may also be arranged in an irregular pattern. For example, the plurality of dispersion holes 151 may be disposed randomly without any regularity.

For example, the dispersion holes 151 may be densely formed in a central portion of the dispersion plate 150. For example, the spacing between the plurality of dispersion holes 151 may decrease toward the central portion of the dispersion plate 150.

The gas mixture may pass through the dispersion holes 151 and be introduced into the main chamber 100. When the dispersion holes 151 are densely formed in approximately a central portion of the dispersion plate 150, the gas mixture may be dispersed in the central portion of the main chamber 100 and be introduced into the main chamber 100. In this case, the gas mixture may be cooled upon contact with the cooling gas. The gaseous iodine included in the gas mixture may be cooled upon contact with the cooling gas and precipitated as fine particles.

A diameter of the dispersion hole 151 may be smaller than a diameter of the precipitated iodine particles. As will be described in detail below, iodine particles I₂ precipitated in the main chamber 100 may move along an upper surface 150a of the dispersion plate 150 toward the edge portion of the dispersion plate 150 and be discharged from the main chamber 100 through the first outlet 130.

The diameter of the dispersion hole 151 may be smaller than the diameter of the precipitated iodine particles so as to prevent the precipitated iodine particles from passing therethrough. The gas mixture introduced into the main chamber 100 through the second inlet 120 may ascend through the dispersion holes 151. The gas mixture may be cooled upon contact with the cooling gas. The gaseous iodine may be cooled upon contact with the cooling gas and precipitated as solid iodine. The gaseous iodine may be precipitated as solid iodine. The precipitated iodine may move along the upper surface 150a of the dispersion plate 150 toward the edge portion of the dispersion plate 150 without passing through the dispersion holes 151.

The upper surface 150a of the dispersion plate 150 may have an upwardly convex shape.

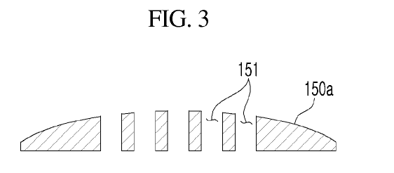

Referring to FIG. 3, the upper surface of the dispersion plate 150 may be a curved surface that is convex upward.

The upper surface of the dispersion plate 150 may be a planar surface protruding upward. For example, a cross-section of the dispersion plate 150 may have a triangular shape. The cross-section of the dispersion plate 150 may have a triangular shape in which the approximate central portion of the dispersion plate 150 protrudes upward.

The gaseous iodine may be cooled upon contact with the cooling gas within the main chamber 100 and precipitated as solid iodine. The precipitated iodine particles may move downward by gravity. The precipitated iodine particles may fall onto the upper surface 150a of the dispersion plate 150. The iodine particles may move along the inclination of the upper surface 150a of the dispersion plate 150 and move toward the edge portion of the dispersion plate 150.

Referring again to FIG. 1, the dispersion plate 150 may be positioned at a height at which the first outlet 130 is in communication with the main chamber 100.

The precipitated iodine may be discharged from the main chamber 100 through the first outlet 130. The iodine particles that move along the dispersion plate 150 may be discharged from the main chamber 100 through the first outlet 130.

A rotary vane unit 160 may be installed above the dispersion plate 150. The rotary vane unit 160 may be operatively connected to a control unit 200. The control unit 200 may control an operation of the rotary vane unit 160. The rotary vane unit 160 may be rotated by the control unit 200.

The rotary vane unit 160 may include a central member 161 and a vane member 162. The vane member 162 may extend in a direction away from the central member 161. The vane member 162 may have a flat plate shape. The vane member 162 may have a narrow width and an elongated length so as not to impede iodine deposition and movement. The vane member 162 may have a curved shape so as to prevent iodine particles from being accumulated on the vane member 162. For example, the vane member 162 may have a cylindrical shape. Alternatively, the vane member 162 may have a twisted shape. The rotary vane unit 160 may be modified to a known shape capable of rotating and moving the precipitated iodine particles toward the edge portion.

A plurality of vane members 162 may be connected to the central member 161.

The vane member 162 may be formed integrally with the central member 161. The vane member 162 may be formed separately from the central member 161 and then connected thereto.

The central member 161 may be rotated by the control unit 200. When the central member 161 rotates, the vane member 162 connected to the central member 161 may rotate. Alternatively, the vane member 162 may be rotatably connected about the central member 161.

When the rotary vane unit 160 rotates, falling iodine particles may be moved toward the edge portion of the dispersion plate 150. The iodine particles precipitated upon contact with the cooling gas in the main chamber 100 may be moved toward the edge portion of the dispersion plate 150 by the rotary vane unit 160. As described above, some embodiments may include no dispersion hole 151 at the edge portion of the dispersion plate 150. The iodine particles moved toward the edge portion of the dispersion plate 150 may be discharged and recovered through the first outlet 130 in communication with the main chamber 100.

A plurality of first outlets 130 may be provided along a circumferential direction of the main chamber 100. The number of first outlets 130 may vary depending on the volume of the main chamber 100. The first outlets 130 may be disposed below the first inlet 110.

A discharge member 131 may be installed in the first outlet 130. The discharge member 131 may allow the iodine precipitated in the main chamber 100 to move through the first outlet 130 and be discharged from the main chamber 100.

For example, the discharge member 131 may include at least one of an auger or a screw.

The discharge member 131 may be operatively connected to the control unit 200. When the iodine precipitated in the main chamber 100 moves to the first outlet 130, the control unit 200 may control the discharge member 131 to operate. When the discharge member 131 operates, the iodine moved to the first outlet 130 may be discharged from the main chamber 100 and be recovered.

The second outlet 140 may be connected to the upper portion of the main chamber 100. A portion of the cooling gas, the gas mixture, and iodine introduced into the main chamber 100 may be carried over to the second outlet 140. A portion of the cooling gas, the gas mixture, and iodine may be discharged through the second outlet 140, thereby preventing an internal pressure of the main chamber 100 from increasing.

A cyclone separator 300 may be connected to the second outlet 140. A portion of the precipitated iodine may be mixed with the cooling gas or the gas mixture and discharged through the second outlet 140. The precipitated iodine discharged through the second outlet 140 may be recovered through the cyclone separator 300.

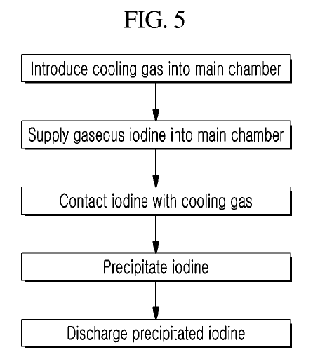

Hereinafter, an iodine recovery process of the iodine recovery apparatus according to an embodiment of the present disclosure will be described with reference to FIG. 5.

A cooling gas may be introduced into the main chamber 100. The cooling gas may be introduced into the main chamber 100 through the first inlet 110. The cooling gas may be provided at a temperature of 50 °C or lower.

The first inlet 110 may be connected to the upper portion of the main chamber 100. The first inlet 110 may be connected to the main chamber 100 so as to be inclined downward toward the main chamber 100. A plurality of first inlets 110 may be provided, each of which may be connected to the main chamber 100.

The second inlet 120 may be connected to the lower portion of the main chamber 100. A gas mixture including gaseous iodine may be introduced into the main chamber 100 through the second inlet 120.

The temperature of the gas mixture introduced into the main chamber 100 may be 150° C to 250° C.

The gas mixture introduced into the main chamber 100 through the second inlet 120 may ascend through the dispersion holes 151 of the dispersion plate 150. Since the dispersion holes 151 are formed in the central portion of the dispersion plate 150, the gas mixture may be dispersed toward the central portion rather than toward the wall surface of the main chamber 100.

The ascending gas mixture may be cooled upon contact with the cooling gas. The gaseous iodine may be cooled and precipitated as solid iodine. The precipitated iodine may fall by gravity. The precipitated iodine may fall onto the upper surface 150a of the dispersion plate 150.

The upper surface 150a of the dispersion plate 150 may have an upwardly convex shape. The iodine falling onto the upper surface 150a of the dispersion plate 150 may move along the inclination of the dispersion plate 150 toward the edge portion of the dispersion plate 150.

Meanwhile, the dispersion gas DG may be introduced into the main chamber 100 through the first inlet 110. The dispersion gas may be sprayed at high pressure. The precipitated iodine particles may be moved toward the edge portion of the dispersion plate 150 by the inflow pressure of the dispersion gas.

The rotary vane unit 160 may be installed above the dispersion plate 150. The rotary vane unit 160 may be rotated by the control unit 200. When the rotary vane unit 160 rotates, the precipitated iodine may be moved. The precipitated iodine may be moved toward the edge portion of the dispersion plate 150.

The dispersion plate 150 may be positioned at a height at which the first outlet 130 is in communication with the main chamber 100. The iodine moved to the edge portion of the dispersion plate 150 may be discharged through the first outlet 130 and be recovered.

A discharge member 131 may be installed in the first outlet 130. The operation of the discharge member 131 may be controlled by the control unit 200. When the discharge member 131 operates, the iodine moved to the first outlet 130 may be discharged. That is, the precipitated iodine may be discharged from the main chamber 100 through the first outlet 130 and be recovered.

The second outlet 140 may be in communication with the upper portion of the main chamber 100.

The cooling gas and the gas mixture introduced into the main chamber 100 may be moved to the upper portion of the main chamber 100. A portion of the precipitated iodine may also be carried over to the upper portion of the main chamber 100.

The cyclone separator 300 may be connected to the second outlet 140. The precipitated iodine discharged through the second outlet 140 may be separated and recovered by the cyclone separator 300.

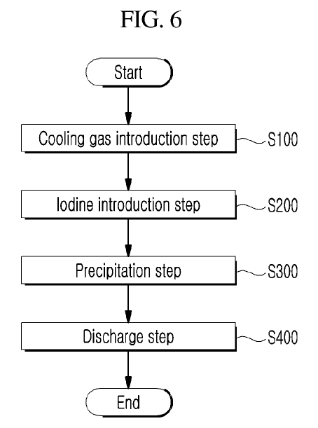

Hereinafter, an iodine recovery method according to an embodiment will be described with reference to FIG. 6. Descriptions overlapping with those of the iodine recovery apparatus according to other embodiments will be omitted.

The iodine recovery method according to an embodiment may include a cooling gas introduction step (S100), an iodine introduction step (S200), a precipitation step (S300), and a discharge step (S400).

In the cooling gas introduction step (S100), the cooling gas CG may be introduced into the main chamber 100 through the first inlet 110 connected to the upper portion of the main chamber 100. The first inlet 110 may be connected to the main chamber 100 so as to be inclined downward toward the main chamber 100. The cooling gas may be introduced into the main chamber 100 through the downwardly inclined first inlet 110 and apply pressure within the main chamber 100 in a direction parallel to an inclined direction of the first inlet 110.

For example, a plurality of first inlets 110 may be connected to the main chamber 100. The first inlets 110 may be disposed to face each other. A cooling gas may be introduced into the main chamber 100 through each of the first inlets 110. Iodine precipitated by the cooling gas introduced from different directions may be moved toward the edge portion of the dispersion plate 150.

In the iodine introduction step (S200), gaseous iodine may be introduced into the main chamber 100 through the second inlet 120 connected to the lower portion of the main chamber 100. The gas mixture GM including gaseous iodine may be introduced into the main chamber 100 through the second inlet 120. The iodine introduced into the main chamber 100 through the second inlet 120 may ascend through the dispersion plate 150 disposed above the second inlet 120. The iodine may ascend through the dispersion holes 151 of the dispersion plate 150.

A plurality of dispersion holes 151 may be formed in the dispersion plate 150. The spacings of at least some of the plurality of dispersion holes 151 may be different from each other.

The spacing between the dispersion holes 151 may decrease toward the central portion of the dispersion plate 150. For example, the dispersion holes 151 may be densely formed toward the central portion of the dispersion plate 150. When the dispersion holes 151 are densely formed toward the central portion of the dispersion plate 150, the gaseous iodine may be densely distributed toward the central portion of the main chamber 100.

The ascending iodine may be cooled upon contact with the cooling gas and precipitated (S300).

The precipitated iodine (I₂) may fall by gravity. The precipitated iodine may fall onto the dispersion plate 150. The dispersion plate 150 may be convexly formed upward. The iodine falling onto the dispersion plate 150 may be moved toward the edge portion of the dispersion plate 150 due to the inclination thereof.

Alternatively, the precipitated iodine may be moved by the pressure of the cooling gas introduced into the main chamber 100 through the downwardly inclined first inlet 110 as described above. Alternatively, the dispersion gas DG may be introduced into the main chamber 100 through the first inlet 110. The dispersion gas may be introduced at high pressure. The precipitated iodine may be moved toward the edge portion of the dispersion plate 150 by the inflow pressure of the dispersion gas.

The rotary vane unit 160 may be installed above the dispersion plate 150. The rotary vane unit 160 may be operatively connected to the control unit 200 and an operation thereof may be controlled by the control unit 200. The rotary vane unit 160 may rotate above the dispersion plate 150. As the rotary vane unit 160 rotates, iodine falling onto the dispersion plate 150 may be moved toward the edge portion of the dispersion plate 150 by a rotational force.

A portion of the main chamber 100 in which the dispersion plate 150 is disposed may be in communication with the first outlet 130. The iodine moved toward the edge portion of the dispersion plate 150 may be discharged from the main chamber bthrough the first outlet 130 (S400).

The discharge member 131 may be installed in the first outlet 130. The discharge member 131 may be operatively connected to the control unit 200. The control unit 200 may control an operation of the discharge member 131. For example, the discharge member 131 may include at least one of an auger and a screw. The discharge member 131 may be operated by the control unit 200, and iodine positioned in the first outlet 130 may be discharged from the main chamber 100.

The precipitated iodine may be discharged from the main chamber 100 through the first outlet 130 and be recovered.

While the preferred embodiments of the present invention have been described in detail above, the scope of the present disclosure is not limited thereto. Various modifications and improvements made by those skilled in the art, utilizing the basic concepts of the present disclosure, also fall within the scope of the present disclosure.

What is claimed is:

1. An iodine recovery apparatus comprising:
a main chamber;
at least one first inlet connected to the main chamber, the at least one first inlet being configured to introduce a cooling gas into the main chamber;
a second inlet connected to the main chamber and spaced apart from the at least one first inlet, the second inlet being configured to introduce iodine in a gaseous state into the main chamber; and
a first outlet connected to the main chamber, the first outlet being configured to discharge, from the main chamber, iodine that has been precipitated in the main chamber,
wherein the main chamber is configured so that the iodine in a gaseous state is cooled by being brought into contact with the cooling gas, thereby causing the iodine in a gaseous state to be precipitated as precipitated iodine.

2. The iodine recovery apparatus according to claim 1, further comprising a dispersion plate disposed within the main chamber and between the at least one first inlet and the second inlet,
wherein the dispersion plate includes a plurality of dispersion holes extending therethrough,
and
wherein the second inlet and the dispersion plate are configured so that the iodine in a gaseous state can pass through the dispersion holes and be dispersed within the main chamber.

3. The iodine recovery apparatus according to claim 2, wherein an upper surface of the dispersion plate has an upwardly convex shape.

4. The iodine recovery apparatus according to claim 2, wherein spacings between at least some of the plurality of dispersion holes extending through the dispersion plate are different from each other.

5. The iodine recovery apparatus according to claim 4, wherein the spacing between the plurality of dispersion holes decreases toward a central portion of the dispersion plate.

6. The iodine recovery apparatus according to claim 2, wherein the dispersion plate is disposed at a height at which the first outlet is in communication with the main chamber.

7. The iodine recovery apparatus according to claim 6, further comprising a rotary vane unit disposed above the dispersion plate,
wherein the rotary vane unit is configured to rotate, thereby moving the precipitated iodine toward an edge portion of the dispersion plate.

8. The iodine recovery apparatus according to claim 1, wherein the at least one first inlet is connected to the main chamber so as to be inclined downward toward the main chamber.

9. The iodine recovery apparatus according to claim 8, wherein the at least one first inlet comprises a plurality of first inlets, and wherein at least one of the plurality of first inlets is configured to introduce a dispersion gas into the main chamber.

10. The iodine recovery apparatus according to claim 1, further comprising a discharge member disposed in the first outlet, the discharge member being configured to discharge the precipitated iodine from the main chamber.

11. The iodine recovery apparatus according to claim 10, wherein the discharge member comprises at least one of an auger and a screw.

12. The iodine recovery apparatus according to claim 1, further comprising a second outlet opening into the main chamber, the second outlet being configured to allow at least one of the cooling gas, the iodine in a gaseous state, and the precipitated iodine in an upper portion of the main chamber to be discharged from the main chamber.

13. The iodine recovery apparatus according to claim 12, further comprising a cyclone separator connected to the second outlet, the cyclone separator being configured to recover the precipitated iodine discharged through the second outlet.

14. An iodine recovery method comprising:
introducing a cooling gas into a main chamber through a first inlet;
introducing iodine in a gaseous state into the main chamber through a second inlet spaced apart from the first inlet;
cooling the iodine in a gaseous state by contacting the iodine in gaseous state with the cooling gas to precipitate the iodine; and
discharging the precipitated iodine from the main chamber.

15. The iodine recovery method according to claim 14, wherein the introducing iodine in a gaseous state into the main chamber further comprises dispersing the iodine and introducing the iodine into the main chamber through a dispersion plate disposed within the main chamber.

16. The iodine recovery method according to claim 15, wherein an upper surface of the dispersion plate is convexly formed upward.

17. The iodine recovery method according to claim 15, wherein the dispersion plate has a plurality of dispersion holes extending therethrough, and
wherein spacings between at least some of the plurality of dispersion holes are different from each other.

18. The iodine recovery method according to claim 17, wherein the spacing between the plurality of dispersion holes decreases toward a central portion of the dispersion plate.

19. The iodine recovery method according to claim 14, wherein the first inlet is connected to the main chamber so as to be inclined downward toward the main chamber.

20. The iodine recovery method according to claim 15, wherein the main chamber further comprises a rotary vane unit disposed above the dispersion plate,
wherein the rotary vane unit is configured to rotate, thereby moving the precipitated iodine toward an edge portion of the dispersion plate.
